(19) United States
(12) Patent Application Publication
(10) Pub. No.: US 2015/0034860 A1
(43) Pub. Date: Feb. 5, 2015

(54) METHOD OF FABRICATING A COMPOSITE MEMBRANE CONTAINING A METAL ION ADSORBENT

(71) Applicant: National Kaohsiung University of Applied Sciences, Kaohsiung City (TW)

(72) Inventors: Wein-Duo Yang, Kaohsiung City (TW); Lin-Hsiang Huang, Kaohsiung City (TW); Zen-Ja Chung, Kaohsiung City (TW)

(73) Assignee: National Kaohsiung University of Applied Sciences, Kaohsiung City (TW)

(21) Appl. No.: 14/143,408

(22) Filed: Dec. 30, 2013

(30) Foreign Application Priority Data
Jul. 30, 2013 (TW) 102127245

(51) Int. Cl. B01J 39/08

(52) U.S. Cl. CPC B01J 39/085
USPC 252/181

(57) ABSTRACT

A method of fabricating a composite membranes containing a metal ion adsorbent, the method comprising the following steps: mixing a metal ion adsorbent powder and a solvent to form a mixture, wherein the solvent is capable of dissolving cellulose; mixing the mixture and cellulose to form a gel blend; removing the solvent from the gel blend, and drying the gel blend to obtain a composite membrane containing a metal ion adsorbent. By means of mixing metal ion adsorbent and cellulose by phase inversion to obtain the composite membrane containing a metal ion adsorbent, the composite membrane containing a metal ion adsorbent can remove heavy metal ions from industrial wastewater.

### BACKGROUND OF THE INVENTION

1. Field of the Invention

The present invention relates to a method of fabricating a composite membrane, and more particularly relates to a method that mixes a metal ion adsorbent powder, a solvent and a cellulose via phase inversion to fabricate a composite membrane containing a metal ion adsorbent.

2. Description of the Prior Arts

The heavy industries such as smelting, electrolysis, plating and dyeing produce large amount of contaminants such as industrial wastewater or radiation contamination, all of which cannot be biodegraded. Therefore, when these contaminants are discharged to the environment, they would enter the food chain via soil, water and air to endanger humans and the organism.

Currently, the conventional method is applying an adsorbent to wastewater containing radioisotopes to remove radioisotopes from the wastewater via the high selectivity of the adsorbent to radioisotopes. The commonly-used adsorbents include zeolite and sodium trititanate in the form of powder or slurry. Even though sodium trititanate has a great effect upon cation exchange and adsorption, the application of sodium trititanate is limited since sodium trititanate powder has to undergo further filtering after the absorption; as for sodium trititanate slurry, the transportation is costly and inconvenient.

### SUMMARY OF THE INVENTION

To overcome the above-mentioned shortcomings, the objective of the present invention is to provide a method for fabricating a composite membrane containing a metal ion adsorbent by mixing a metal ion adsorbent and cellulose of phase inversion for removing heavy metal ions from a solution.

To achieve the above objective, the method in accordance with the present invention comprises the following steps:

mixing a metal ion adsorbent powder and a solvent to form a mixture,

wherein the solvent is capable of dissolving cellulose;

mixing the mixture and cellulose to form a gel blend;

removing the solvent from the gel blend, and drying the gel blend to obtain a composite membrane containing a metal ion adsorbent.

Preferably, the metal ion adsorbent powder is composed of oxygen atom at amount ranging from 60% to 63%, sodium atom at an amount ranging from 14% to 15%, aluminum atom at an amount ranging from 10% to 11%, and silicon atom at an amount ranging from 10% to 13%.

Preferably, the metal ion adsorbent powder is sodium trititanate (Na₂Ti₃O₇) or zeolite powder.

Preferably, the solvent capable of dissolving cellulose includes, but is not limited to, 1-methyl-2-pyrrolidone (NMP), chloroform, dichloromethane (DCM), oxolane (THF) and dimethylformide (DMF).

Preferably, the cellulose includes, but is not limited to, cellulose acetate (CA), polyimide (PI), polyethersulfone (PES), and cellulose triacetate.

Preferably, the weight ratio of the cellulose to the metal ion adsorbent in the mixture is between 1:0.1 and 1:1.5.

Preferably, the weight ratio of the cellulose to the metal ion adsorbent in the mixture is between 1:0.4 and 1:0.8.

According to the present invention, the step of mixing a metal ion adsorbent powder and a solvent further includes mixing them for a period ranging from 20 minutes to 40 minutes.

According to the present invention, the step of mixing the mixture and cellulose further includes vibrating the mixture by ultrasound for 10 minutes to 20 minutes, and then mixing the mixture and cellulose for a period ranging from 4 hours to 6 hours.

According to the present invention, the step of removing the solvent from the gel blend further includes placing the gel blend in a petri dish. Due to that the gel blend is water-insoluble, when the gel blend is placed in a petri dish containing water, the water can dilute and remove the solvent from the gel blend.

In a second aspect, the present invention provides a composite membrane containing a metal ion adsorbent, wherein the composite membrane containing a metal ion adsorbent is capable of removing heavy metal ions from a solution, and the removal rate of metal ions is between 30% and 60%.

According to the present invention, the removal rate of metal ions is obtained by first subtracting the metal ion concentration of the solution filtered through the composite membrane containing a metal ion adsorbent from the initial concentration of the solution, and then dividing the difference by the initial concentration of the solution.

Preferably, the composite membrane containing a metal ion adsorbent is composed of carbon atom at amount ranging from 40% to 53%, oxygen atom at amount ranging from 40% to 48%, sodium atom at amount ranging from 2% to 6%, aluminum atom at amount ranging from 1% to 5%, and silicon atom at amount ranging from 1% to 5%.

Preferably, the thickness of the composite membrane containing a metal ion adsorbent was between 2 mm and 3 mm, and the loading is between 0.1 kg and 0.8 kg.

In a third aspect, the present invention provides a filtering device comprising the above-mentioned composite membrane containing a metal ion adsorbent, wherein the filtering device comprises:

at least one carrier, the carrier having multiple composite membranes containing a metal ion adsorbent; and

a column for a solution to pass through, wherein the at least one carrier is mounted in the column and a periphery of the carrier connects to a wall of the column.

Preferably, the filtering device comprises multiple carriers, and the multiple carriers separately comprise multiple composite membranes containing a metal ion adsorbent.

Preferably, the removal rate of metal ions of the filtering device is between 30% and 60%.

Preferably, the filtering device further comprises a pump, which is connected to the column.

In a fourth aspect, the present invention provides a method according to the above-mentioned filtering device, which comprises steps of:

passing a solution containing heavy metal ions through the column comprising the composite membranes containing a metal ion adsorbent to remove heavy metal ions from the solution.

According to the present invention, the term “heavy metal ion” means that relative density of a metal is larger than 5, including, but not limited to, lead, arsenic, mercury, cadmium, chromium, nickel, stannum, aluminium, selenium, antimony, potassium, sodium, calcium, magnesium, iron, zinc, copper, manganese, titanium, boron, strontium, barium, vanadium, and cobalt. As regards to the natural environment, the term “heavy metal ion” means a metal or a metalloid that has distinct toxicity and is not biodegradable by microorganism, such as mercury, cadmium, lead, zinc, copper, cobalt, nickel, stannum and arsenic.

Preferably, said heavy metal ions include, but are not limited to, actinoids (An) and lanthanides (Ln), wherein the actinoids are actinium (Ac) of No. 89 atomic number to lawrencium (Lw) of No. 103 atomic number, 15 radiation elements in total; wherein the lanthanides are anthanum (Ln) of No. 57 of atomic number to lutetium (Lu) of No. 71 of atomic number, 15 radiation elements in total.

Based on the above-mentioned, the present invention, in comparison with the prior arts, has the following advantages:

1. Due to phase inversion caused by solvent volatilization, the metal ion adsorbent powder, the solvent and cellulose can be precipitated to form a continuous phase gel blend. The gel blend is dried with the solvent removed from the gel blend to form a composite membrane containing a metal ion adsorbent with pores.

2. The composite membranes containing a metal ion adsorbent can be placed on a carrier, and then multiple carriers can be mounted in a column. A heavy metal ion solution can flow through the composite membrane containing a metal ion adsorbent that is placed on the carrier in the column to remove heavy metal ions from a solution.

3. When the adsorbent is sodium trititanate (Na₂Ti₃O₇) and the solution has cation ion of inner transition element, metal cation ion of actinoids and lanthanides can have access into the structure of the composite membranes containing a metal ion adsorbent to form a stable metal salt of actinoids titanate or lanthanides trititanate, and to remove cation ion from the solution.

4. The composite membranes containing a metal ion adsorbent in accordance with the present invention is made by mixing a metal ion adsorbent and cellulose at a specific ratio. The composite membranes containing a metal ion adsorbent display a great loading for filtering heavy metal and industrial wastewater.

### BRIEF DESCRIPTION OF THE DRAWINGS

FIG. 1A is a crystal phase result of a metal ion adsorbent powder of the present invention by field-emission scanning electron microscopy (FE-SEM);

FIG. 1B is a crystal phase result of the metal ion adsorbent powder of the present invention by transmission electron microscopy (TEM);

FIGS. 2A to 2C are crystal phase results of samples 1 to 3 of the examples of the present invention, obtained by FE-SEM;

FIGS. 3A to 3C are crystal phase results of samples 5 to 7 of the examples of the present invention, obtained by FE-SEM;

FIGS. 3D to 3E are crystal phase results of samples 4 and 8 of the examples of the present invention, obtained by FE-SEM;

FIG. 4A shows intensity of diffraction peaks of samples 1 to 4 of the composite membranes containing a metal ion adsorbent of the present invention by X-ray diffraction (XRD), wherein (A) is the diffraction peak with only 1 g metal ion adsorbent; (B) is the diffraction peak with only 1 g cellulose acetate (sample 1); (C) is the diffraction peaks when cellulose acetate:metal ion adsorbent=1:0.5 (sample 2); (D) is the diffraction peak when cellulose acetate:metal ion adsorbent=1:1 (sample 3); (E) is the diffraction peak when cellulose acetate:metal ion adsorbent=1:1.5 (sample 4).

FIG. 4B shows intensity of diffraction peaks of samples 5 to 8 of the composite membranes containing a metal ion adsorbent of the present invention by X-ray diffraction (XRD), wherein (A) is the diffraction peak with only 1 g metal ion adsorbent; (B) is the diffraction peak with only 1 g cellulose triacetate (sample 5); (C) is the diffraction peak when cellulose triacetate:metal ion adsorbent=1:0.5 (sample 6); (D) is the diffraction peak when cellulose triacetate:metal ion adsorbent=1:1 (sample 7); (E) is the diffraction peak when cellulose triacetate:metal ion adsorbent=1:1.5 (sample 8).

FIG. 5A shows loading-shifting patterns of samples 1 to 4 of the composite membranes containing a metal ion adsorbent of the present invention by lacerating machine, wherein (A) is the loading-shifting pattern with only 1 g cellulose acetate (sample 1); (B) is the loading-shifting pattern when cellulose acetate:metal ion adsorbent=1:0.5 (sample 2); (C) is the loading-shifting pattern when cellulose acetate:metal ion adsorbent=1:1 (sample 3); (D) is the loading-shifting pattern when cellulose acetate:metal ion adsorbent=1:1.5 (sample 4).

FIG. 5B shows loading-shifting patterns of samples 5 to 8 of the composite membranes containing a metal ion adsorbent of the present invention by lacerating machine (from left to right: C, D, B, A), wherein (A) is the loading-shifting pattern with only 1 g cellulose triacetate (sample 5); (B) is the loading-shifting pattern when cellulose triacetate:metal ion adsorbent=1:0.5 (sample 6); (C) is the loading-shifting pattern when cellulose triacetate:metal ion adsorbent=1:1 (sample 7); (D) is the loading-shifting pattern when cellulose triacetate:metal ion adsorbent=1:1.5 (sample 8).

FIG. 6 is a perspective view of the composite membrane containing a metal ion adsorbent applied to a carrier;

FIG. 7 is a partially cross-sectional view of a filtering device with the multiple composite membranes containing a metal ion adsorbent; and

FIG. 8 is another partially cross-sectional view of the filtering device with the multiple composite membranes containing a metal ion adsorbent.

### DETAILED DESCRIPTION OF THE PREFERRED EMBODIMENTS

Other objectives, advantages and novel features of the invention will become more apparent from the following detailed description when taken in conjunction with the accompanying drawings.

### Example 1

### Analysis of the Composition of a Metal Ion Adsorbent Powder

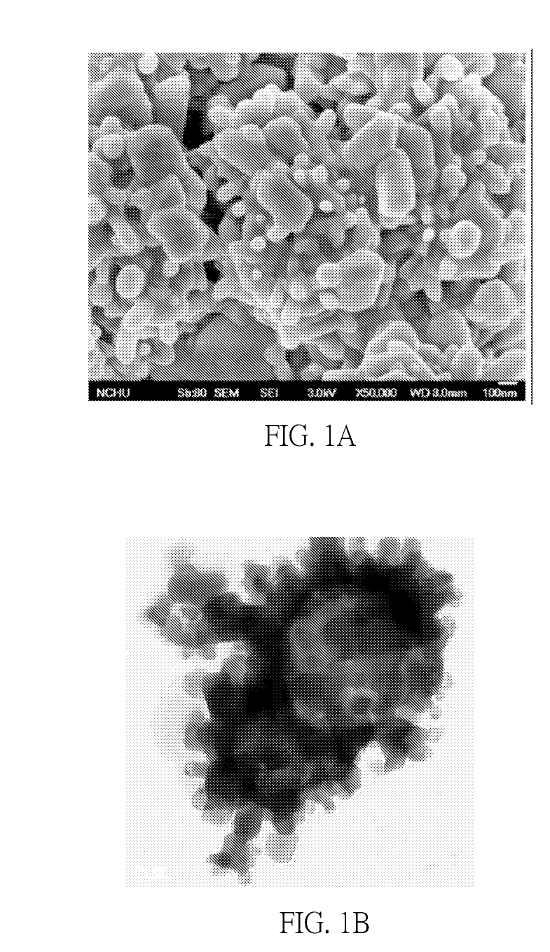

A metal ion adsorbent powder (obtained from Institute of Nuclear Energy Research, Taiwan) was prepared for analysis of the powder's composition by field-emission scanning electron microscopy (FE-SEM) and transmission electron microscopy (TEM). As shown in FIGS. 1A to 1B, an appearance of the metal ion adsorbent powder as accumulated stubs to form a 1 μm spherical granule. The metal ion adsorbent powder was also measured by energy dispersive spectrometer (EDS) as composed of oxygen atom at amount ranging from 60% to 63%, sodium atom at amount ranging from 14% to 15%, aluminum atom at amount ranging from 10% to 11%, and silicon atom at amount ranging from 10% to 13%.

### Example 2

### Preparation of a Composite Membrane Containing a Metal Ion Adsorbent

TABLE 1
The ratio of cellulose acetate or cellulose
triacetate to metal ion adsorbent

| | | | metal ion |
|---|---|---|---|
| | cellulose acetate (g) | cellulose triacetate (g) | adsorbent (g) |
| Sample 1 | 1 | | 0 |
| Sample 2 | 1 | | 0.5 |
| Sample 3 | 1 | | 1 |
| Sample 4 | 1 | | 1.5 |
| Sample 5 | | 1 | 0 |
| Sample 6 | | 1 | 0.5 |
| Sample 7 | | 1 | 1 |
| Sample 8 | | 1 | 1.5 |

The metal ion adsorbents to which Table 1 referred were mixed separately with 10 g 1-methyl-2-pyrrolidone (NMP) for 30 minutes to form a mixture. The mixture was vibrated for 15 minutes by ultrasound, and then 1 g cellulose acetate or cellulose triacetate was added to the mixture and stirred for 5 hours to form a gel blend. The 1-methyl-2-pyrrolidone (NMP) was removed from the gel blend via water bath and was dried to obtain a composite membrane containing a metal ion adsorbent as samples 1 to 8 in Table 1. The diameter of the composite membrane containing a metal ion adsorbent was about 5.5 cm, and the thickness of the composite membrane containing a metal ion adsorbent was between 2 mm and 3 mm.

### Example 3

### Analysis of the Composite Membrane Containing a Metal Ion Adsorbent by Field-Emission Scanning Electron Microscopy (FE-SEM)

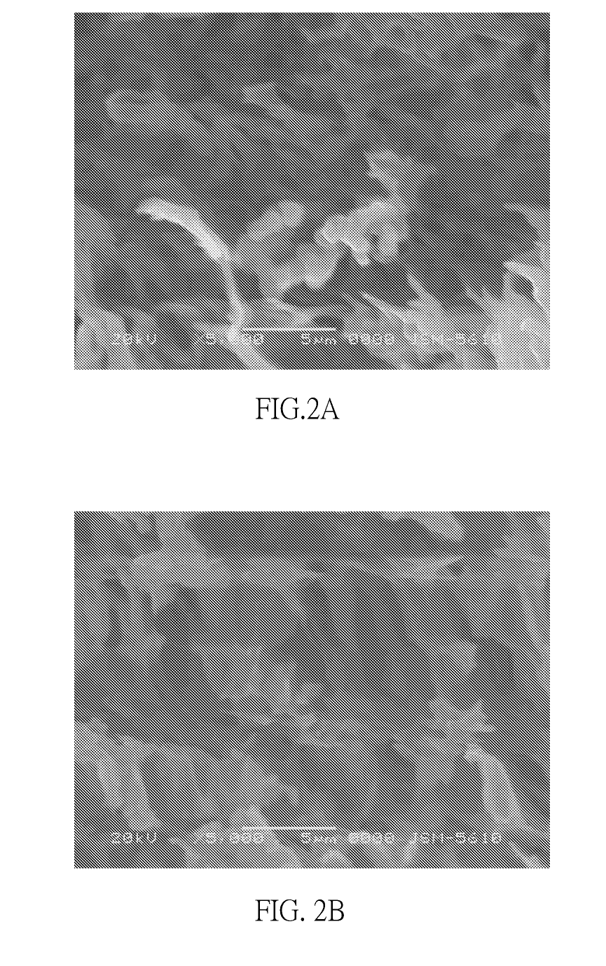

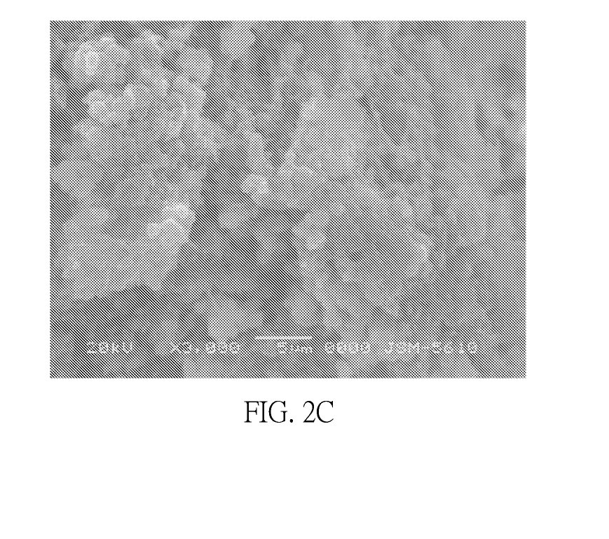

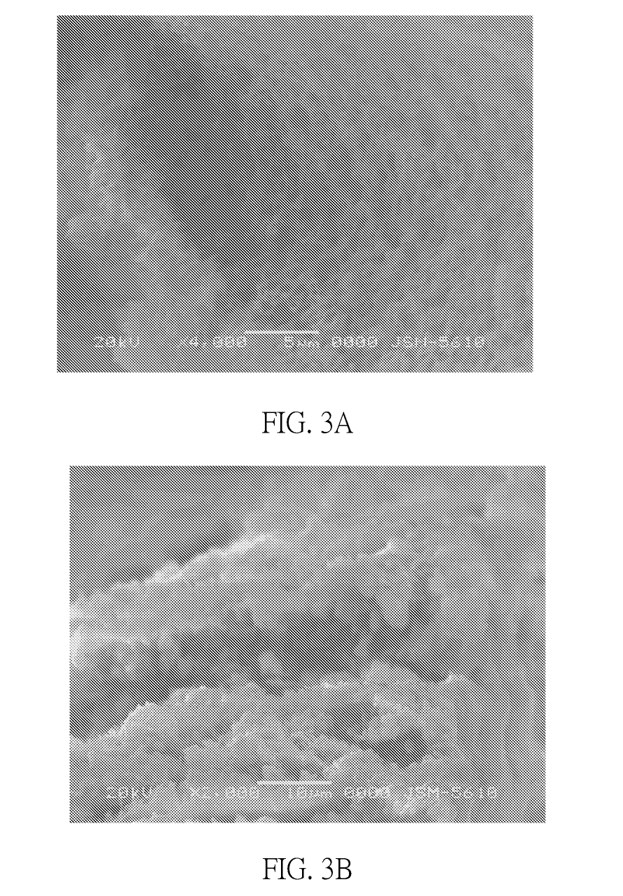

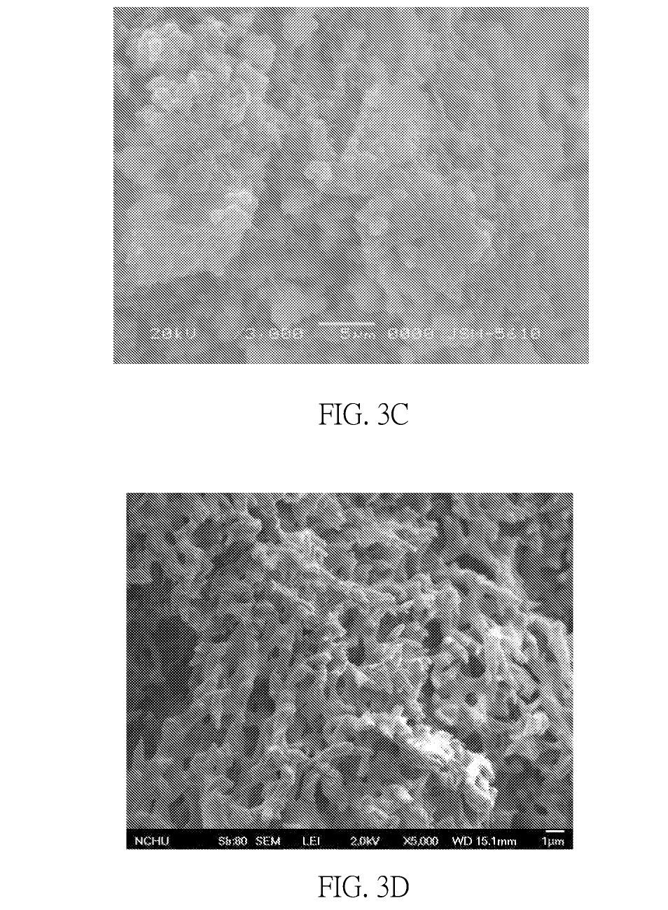

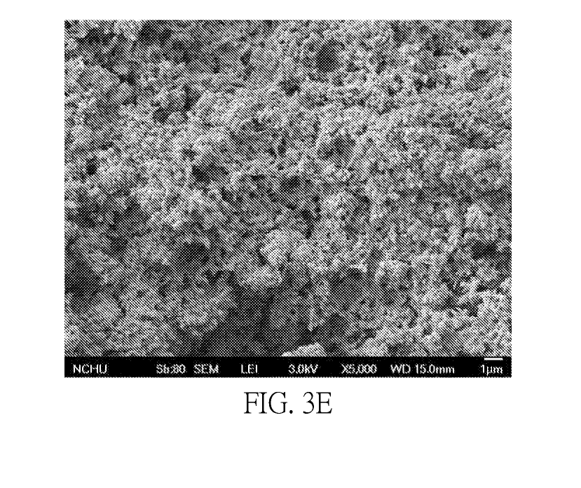

Samples 1 to 3, and samples 5 to 7 of the composite membrane obtained from Example 2 were observed by field-emission scanning electron microscopy (FE-SEM). As shown in FIGS. 2A to 2C and FIGS. 3A to 3C, the cross sections of samples 1 to 3 and samples 5 to 7 were all in form of spongiform pores. As shown in FIGS. 3D (sample 4) to 3E (sample 8), the agglomeration was increasing in accordance with the increasing addition of metal ion adsorbent.

### Example 4

### Analysis of the Composite Membrane Containing a Metal Ion Adsorbent by Energy Dispersive Spectrometer (EDS) and Scanning Electron Microscope (SEM)

Samples 4 and 8 of the composite membrane obtained from Example 2 were observed by energy dispersive spectrometer (EDS) and Scanning Electron Microscope (SEM). Sample 4 of the composite membrane containing a metal ion adsorbent was comprised of 52.17% carbon atom, 42.3% oxygen atom, 2.28% sodium atom, 1.54% aluminum atom and 1.64% silicon atom. Sample 8 of the composite membrane containing a metal ion adsorbent was comprised of 40.54% carbon atom, 45.14% oxygen atom, 5.72% sodium atom, 4.34% aluminum atom and 4.26% silicon atom. The carbon atom of samples 4 and 8 came from cellulose. As shown in FIGS. 3D to 3E, the metal ion adsorbent powder was inlaid in cellulose membrane.

### Example 5

### Analysis of the Composite Membrane Containing Metal Ion Adsorbent by X-ray Diffractometer

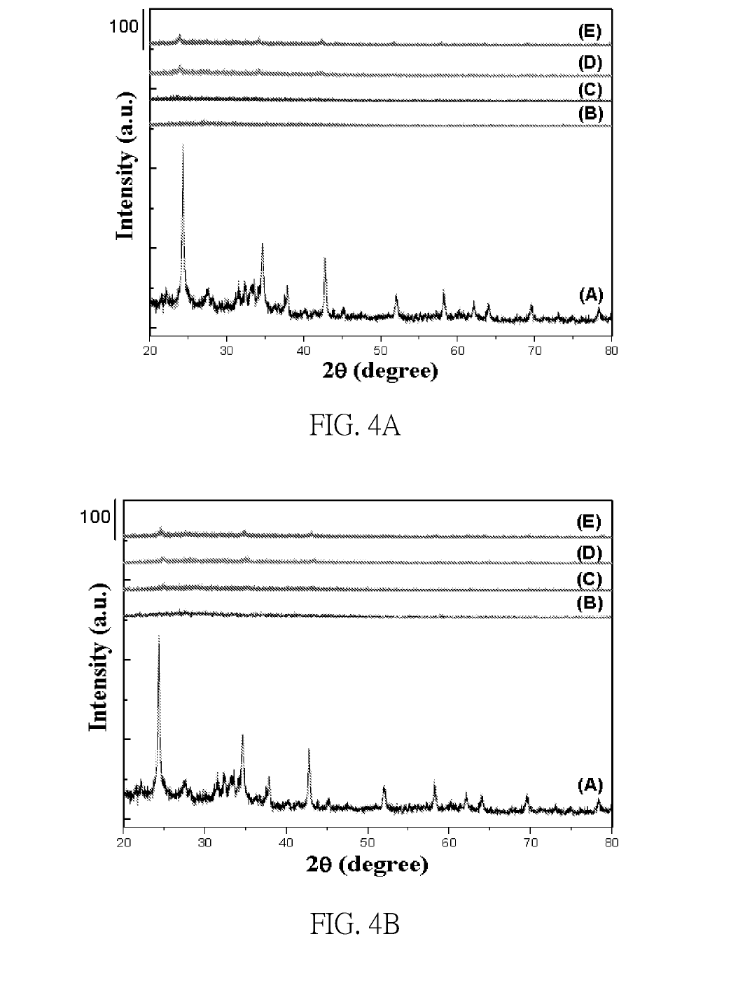

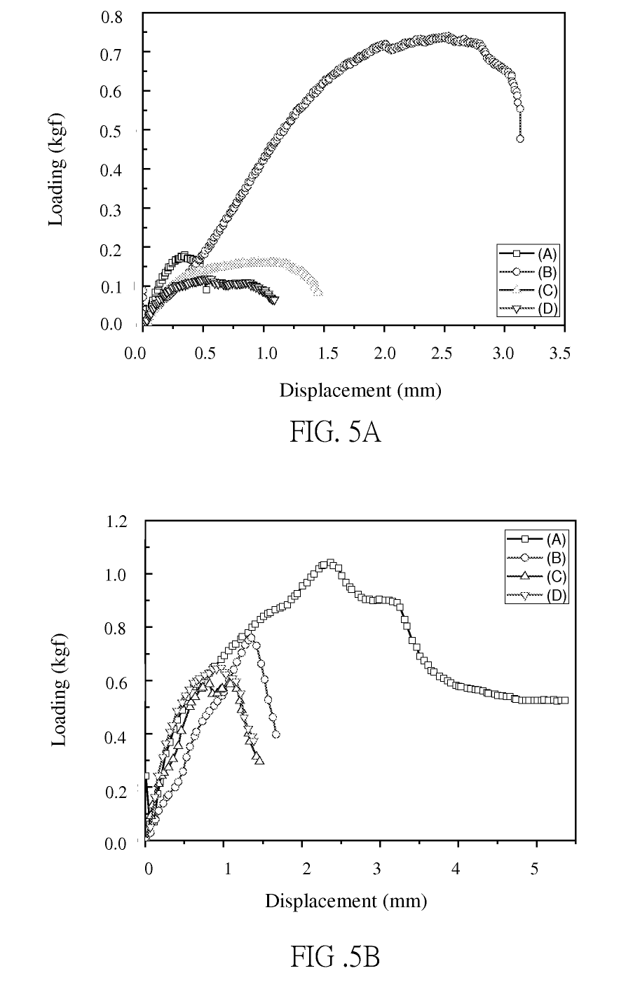

Samples 2 to 4, and samples 6 to 8 of the composite membrane obtained from Example 2 were measured by X-ray diffractometer. As shown in FIGS. 4A to 4B, the main peaks of the composite membranes containing a metal ion adsorbent were respectively 2θ=24.37°, 34.67°, and 42.75°. A few peaks were formed in accordance with the increasing addition of metal ion adsorbent, and the location of the a few peaks was identical to the main peak of only 1 g metal ion adsorbent. The peak value was significant when the addition of metal ion adsorbent was 1.5 g, which validates that the metal ion adsorbent powder was inlaid in cellulose membrane.

### Example 6

### Analysis of Stretch of the Composite Membrane Containing a Metal Ion Adsorbent

Samples 2 to 4 and samples 6 to 8 of the composite membrane obtained from Example 2 were measured by material testing machine.

TABLE 2
Loading of samples 1 to 4

| | Loading ratio of cellulose acetate to | |
|---|---|---|
| | metal ion adsorbent | Loading (kg) |
| Sample 1 | 1:0 | 0.18 |
| Sample 2 | 1:0.5 | 0.74 |
| Sample 3 | 1:1 | 0.16 |
| Sample 4 | 1:1.5 | 0.12 |

As shown in FIG. 5A and Table 2, the loading of cellulose acetate having non-metal ion adsorbent was 0.18 kg. When the addition of metal ion adsorbent was 0.5 g, the loading is the highest, and the loading was lower than cellulose acetate membrane when the addition of metal ion adsorbent was between 1 g and 1.5 g.

TABLE 3
Loading of samples 5 to 8

| | Loading ratio of cellulose triacetate | |
|---|---|---|
| | to metal ion adsorbent | Loading (kg) |
| Sample 5 | 1:0 | 1.04 |
| Sample 6 | 1:0.5 | 0.76 |
| Sample 7 | 1:1 | 0.59 |
| Sample 8 | 1:1.5 | 0.65 |

As shown in FIG. 5B and Table 3, the loading of cellulose triacetate having non-metal ion adsorbent was 1.04 kg. The loading was decreasing in accordance with the increasing addition of metal ion adsorbent.

In comparison with FIGS. 3G to 3H, when the addition of metal ion adsorbent was separately 1 g (samples 3 and 7) and 1.5 g (samples 4 and 8), the agglomeration of metal ion adsorbent resulted in lower mechanical strength of the composite membrane containing metal ion adsorbent.

### Example 7

### Analysis of Filtering of the Composite Membrane Containing a Metal Ion Adsorbent

A 100 ml solution containing 100 ppm strontium nitrate [Si(NO₃)₂] was prepared for absorbing-filtering analysis, and then the metal ions of strontium nitrate were filtered by the composite membrane containing a metal ion adsorbent to obtain a filtered solution. The filtered solution was measured by atomic absorption spectrophotometer (AAS) to obtain the removal rate of metal ions relative to the composite membrane containing a metal ion adsorbent. The formula of removal rate is as follows: removal rate (%)=(Cₒ-Cₑ)/Cₒ×100%, wherein Cₒ is an initial concentration of the solution, C ₑ is a concentration of the filtered solution.

TABLE 4
Removal rate of metal ions under only metal ion adsorbent

| Weight of metal ion | Cₒ | Cₑ | adsorption | Removal |
|---|---|---|---|---|
| adsorbent (g) | (mg/L) | (mg/L) | (mg/L) | rate (%) |
| 0.5 | 94.73 | 57.00 | 37.73 | 39.83 |
| 1 | 94.73 | 1.70 | 93.03 | 98.20 |
| 1.5 | 94.73 | 0.62 | 94.11 | 99.34 |

Table 4 was a blank trial as follows: 0.5 g, 1 g, 1.5 g metal ion adsorbents were separately added to strontium nitrate solution, and then the strontium nitrate solution containing metal ion adsorbent were separately filtered for absorbing analysis. The removal rate of 1.5 g metal ion adsorbent to strontium was 99.34%.

TABLE 5
Removal rate of composite membrane containing metal ion
adsorbent relative to ratio of cellulose acetate to metal ion adsorbent.

| Weight ratio of | | | | |
|---|---|---|---|---|
| cellulose acetate to | Cₒ | Cₑ | adsorption | Removal |
| metal ion adsorbent | (mg/L) | (mg/L) | (mg/L) | rate (%) |
| 1:0.5 | 94.73 | 62.89 | 31.84 | 33.61 |
| 1:1 | 94.73 | 60.69 | 34.03 | 35.93 |
| 1:1.5 | 94.73 | 49.98 | 44.75 | 47.24 |

Table 5 demonstrated the absorbing analysis results of samples 2 to 4, which were composite membranes containing various ratios of cellulose acetate to metal ion adsorbent. Removal rate of metal ions was increasing in accordance with the increasing addition of metal ion adsorbent. The highest removal rate of the composite membrane containing a metal ion adsorbent with cellulose acetate was 47.24%.

TABLE 6
Removal rate of the composite membrane containing a metal ion
adsorbent relative to ratio of cellulose triacetate to metal ion adsorbent.

| Weight ratio of | | | | |
|---|---|---|---|---|
| cellulose triacetate to | Cₒ | Cₑ | adsorption | Removal rate |
| metal ion adsorbent | (mg/L) | (mg/L) | (mg/L) | (%) |
| 1:0.5 | 94.73 | 61.26 | 33.47 | 35.33 |
| 1:1 | 94.73 | 53.4 | 41.33 | 45.63 |
| 1:1.5 | 94.73 | 38.44 | 56.29 | 59.43 |

Table 6 demonstrated the results of absorbing analysis of samples 6 to 8, which were composite membranes containing various ratios of cellulose acetate to metal ion adsorbent. Removal rate of metal ions was increasing in accordance with the increasing addition of metal ion adsorbent. The highest removal rate of composite membrane containing metal ion adsorbent with cellulose triacetate was 59.43%.

Next, three layers of composite membranes of sample 8 were stacked for absorbing analysis.

TABLE 7
Removal rate of the composite membranes containing a metal
ion adsorbent of sample 8 with three layers stacking

| | Cₒ | Cₑ | adsorption | Removal |
|---|---|---|---|---|
| | (mg/L) | (mg/L) | (mg/L) | rate (%) |
| Sample 8 | 94.73 | 9.49 | 85.24 | 89.98 |

As shown in Table 7, removal rate of the composite membrane containing a metal ion adsorbent stacked as three layers was 89.98%.

### Example 8

### A Filtering Device Having the Composite Membrane Containing a Metal Ion Adsorbent

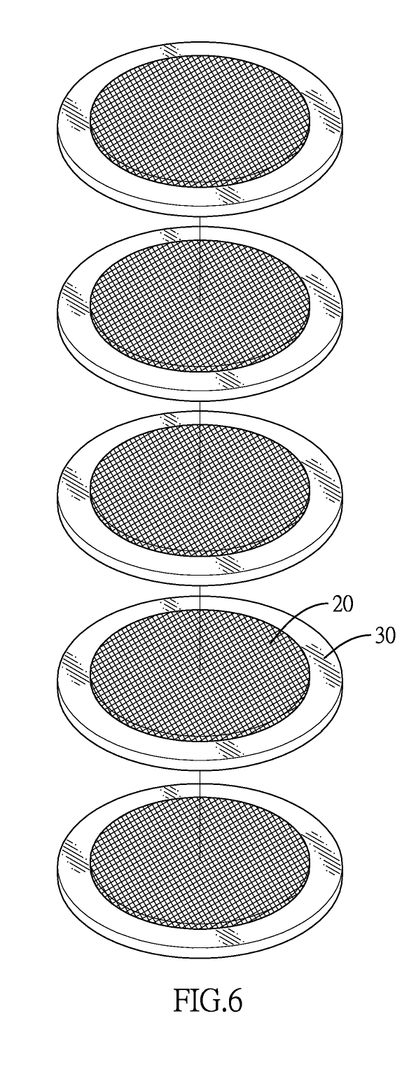

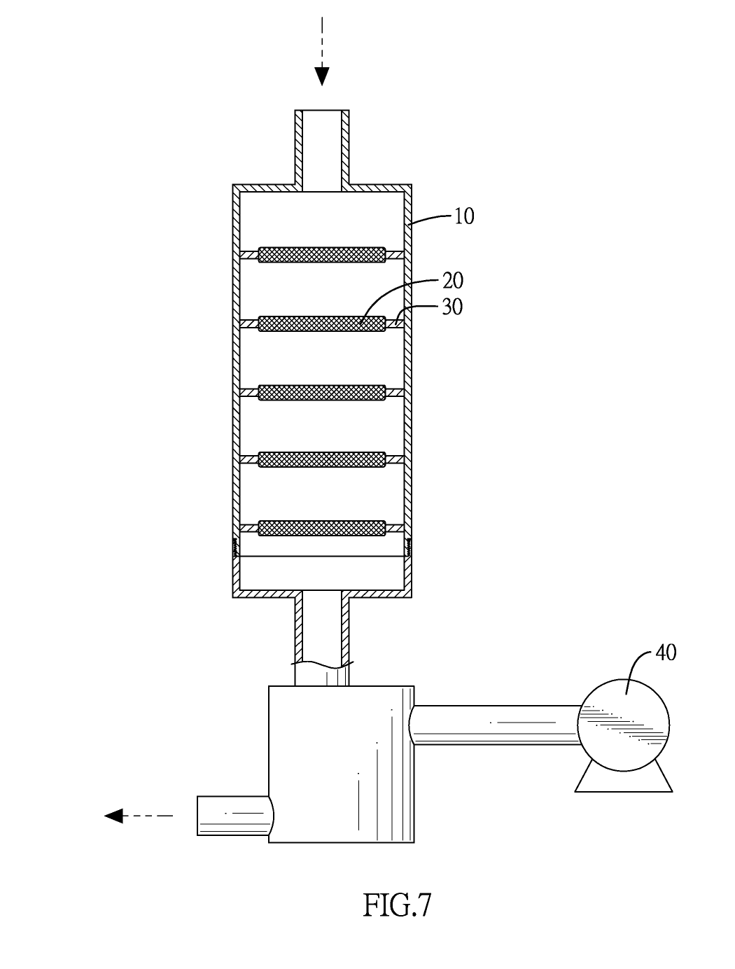

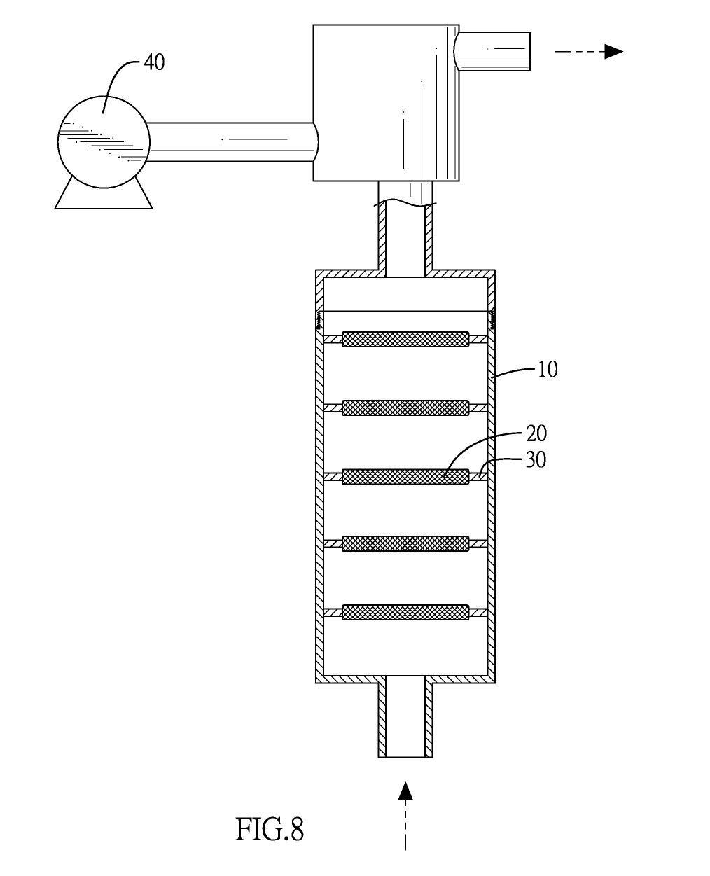

As shown in FIG. 6, multiple composite membranes 20 containing a metal ion adsorbent (Sample 8), obtained from Example 2, were stacked and placed on a carrier 30. As shown in FIG. 7 or 8, the carrier 30 having multiple composite membranes 20 containing a metal ion adsorbent was mounted in a column 10, and a periphery of the carrier 30 was connected to a wall of the column 10, to form a filtering device.

As shown in FIG. 7, when the filtering device is in use, a solution containing heavy metal ions can flow through the multiple composite membranes 20 containing a metal ion adsorbent in the column 10 from top to bottom. The filtering device further comprise a pump 40, and the pump 40 can discharge the filtered solution out of the column 10 from the lower end of the column 10. As shown in FIG. 8, the solution containing heavy metal ions can flow through the multiple composite membranes 20 containing a metal ion adsorbent in the column 10 from bottom to top, driven by the pump 40, such that the filtered solution were discharged out of the column 10 from the upper end of the column 10.

What is claimed is:

1. A method of fabricating a composite membrane containing a metal ion adsorbent, comprising steps of:
mixing a metal ion adsorbent powder and a solvent to form a mixture, wherein the solvent is capable of dissolving cellulose;
mixing the mixture and cellulose to form a gel blend;
removing the solvent from the gel blend, and then drying the gel blend to obtain the composite membrane containing a metal ion adsorbent, wherein the composite membrane containing a metal ion adsorbent is capable of removing heavy metal ions from a solution.

2. The method according to claim 1, wherein the metal ion adsorbent powder is composed of oxygen atom at amount ranging from 60% to 63%, sodium atom at an amount ranging from 14% to 15%, aluminum atom at an amount ranging from 10% to 11%, and silicon atom at an amount ranging from 10% to 13%.

3. The method according to claim 1, wherein the metal ion adsorbent powder is sodium trititanate (Na₂Ti₃O₇) or zeolite powder.

4. The method according to claim 1, wherein the solvent capable of dissolving cellulose is 1-methyl-2-pyrrolidone (NMP), chloroform, dichloromethane (DCM), oxolane (THF) or dimethylformide (DMF).

5. The method according to claim 1, wherein the cellulose is cellulose acetate (CA), polyimide (PI), polyethersulfone (PES) or cellulose triacetate.

6. The method according to claim 1, wherein the weight ratio of the cellulose to the metal ion adsorbent in the mixture is between 1:0.1 and 1:1.5.

7. The method according to claim 1, wherein the weight ratio of the cellulose to the metal ion adsorbent in the mixture is between 1:0.4 and 1:0.8.

8. The method according to claim 1, wherein the composite membrane containing a metal ion adsorbent is composed of carbon atom at amount ranging from 40% to 53%, oxygen atom at amount ranging from 40% to 48%, sodium atom at amount ranging from 2% to 6%, aluminum atom at amount ranging from 1% to 5%, and silicon atom at amount ranging from 1% to 5%.

9. The method according to claim 1, wherein the thickness of the composite membrane containing a metal ion adsorbent is between 2 mm and 3 mm, and the loading of the composite membrane containing a metal ion adsorbent is between 0.1 kg and 0.8 kg.

10. The method according to claim 1, wherein the removal rate of the composite membrane containing a metal ion adsorbent is between 30% and 60%.
